(19) United States
(12) Patent Application Publication
(10) Pub. No.: US 2025/0010474 A1
(43) Pub. Date: Jan. 9, 2025

(54) METHOD FOR COLLISION CHECKING OF A MACHINING PROCESS WITH A SUBSTITUTE WORKPIECE

(71) Applicant: Reishauer AG, Wallisellen (CH)

(72) Inventors: Erwin Sennhauser, Kleinandelfingen (CH); Oliver Fellmann, Binz (CH); Lorenz Winkler, Winterthur (CH)

(73) Assignee: Reishauer AG, Wallisellen (CH)

(21) Appl. No.: 18/892,488

(22) Filed: Sep. 22, 2024

Related U.S. Application Data
(63) Continuation of application No. PCT/EP2023/056251, filed on Mar. 10, 2023.

(30) Foreign Application Priority Data
Mar. 23, 2022 (CH) CH000318/2022

(51) Int. Cl. B25J 9/16; B25J 11/00

(52) U.S. Cl. CPC B25J 9/1666; B25J 11/005

(57) ABSTRACT

A method for collision checking of a machining process is disclosed. A process-specific cycle is provided for the machining process. Multiple machining components are moved relative to one another with at least one machine axis on a machine tool. The machining components have at least one workpiece and one tool. The workpiece rotates about a workpiece axis and the tool rotates about a tool axis. At least one checking position is identified and corresponds to a relative position of the machining components set with the at least one machine axis. In order to check a respective checking position for collisions, a substitute machining component is used during the reproducing, which is a replica of the corresponding machining component.

### CROSS-REFERENCE TO RELATED APPLICATIONS

This continuation application claims priority to PCT/EP2023/056251 filed on Mar. 10, 2023 which has published as WO 2023/180102 A1 and also the Swiss application number CH000318/2022 filed on Mar. 23, 2022, the entire contents of which are fully incorporated herein with these references.

### DESCRIPTION

### Field of the Invention

The invention relates to a method for collision checking of a machining process, wherein a process-specific cycle is provided for the machining process, during which cycle multiple machining components are to be moved relative to one another with at least one machine axis on a machine tool, wherein the machining components comprise at least one workpiece and one tool, and at least during a part of the process-specific cycle the workpiece is to rotate about a workpiece axis and the tool is to rotate about a tool axis.

### Background of the Invention

Such a method is known from EP 2 306 253 B1.

In the manufacture of gears, gearboxes and other workpieces, a wide variety of machine tools are used in which an, in particular, toothed tool rotating about a tool axis engages in an, in particular, toothed workpiece rotating about a workpiece axis. For this purpose, the tool and the workpiece and possibly further machining components on the machine tool must be moved relative to one another in a suitable manner, in particular, for infeed and feed. An example of such a machine tool is found in CH 715 794 B1.

In the course of such a machining process, a process-specific cycle is run through, during which the machining components involved, comprising at least the workpiece and the tool, are moved relative to each other by means of at least one machine axis.

When setting up a new machining process on a machine tool, it is necessary to check whether a planned process-specific cycle is free from unintentional collisions of the machining components (“collision check”). For example, in the process-specific cycle, a part of the tool not used for machining, or a part of a tool holder of the tool, must not come into contact with the workpiece or a clamping means of the workpiece.

In many cases, a collision check is performed optically with the means of the machine tool. The original machining components are mounted on the machine tool, and desired positions of the machining components are carefully approached, usually step by step, under the supervision and control of an operator, as far as possible.

During this process, the operator repeatedly looks at the machining components and assesses whether an unintentional collision will occur. If necessary, the approach to a desired position is aborted.

This procedure is often difficult. In many cases, the operator has a poor view of the machining components, even if he repeatedly opens the machine housing during the collision check with the machine tool switched off. Often, the workpiece conceals other machining components, in particular, when the workpiece is to be machined on a radially inner side. By means of optical aids such as mirrors or endoscopes, the view for the operator can sometimes be improved, but often the space is not sufficient for the use of such aids. Another disadvantage is that the operator often cannot even approach a position of the machining components that is actually to be checked due to a beginning mutual engagement of the workpiece and tool during a collision check. The operator must then mentally add a remaining infeed or a feed that has not yet occurred to the set position and then mentally estimate the collision situation. If the operator does not detect an impending collision during the step-by-step approach to a desired position, the original machining components may be damaged during the collision check, in particular, replacing a tool in the event of damage is usually very expensive.

It is also known to perform collision checks geometrically/mathematically. For this purpose, the 3D data of all machining components involved are required, with sufficient accuracy. The 3D data and the planned process-specific cycle are entered into a specific software. The software checks whether undesired collisions will occur. However, the effort for providing and, if necessary, updating the 3D data is high, and the software is complex to program, or licenses for the corresponding software are usually expensive. An example of a mathematical collision check is described in EP 2 306 253 B1.

In addition, it is also known from EP 2 849 014 A2 to perform a mathematical collision monitoring during gear machining on a gear cutting machine.

### SUMMARY OF THE INVENTION

### Object of the Invention

It is the object of the invention to provide a simple, inexpensive and safe method for collision checking of a machining process.

### Brief Description of the Invention

This object is achieved according to the invention by a method of the type mentioned at the outset, which provides that
in the process-specific cycle, at least one checking position is identified which is checked for collisions with respect to the machining components,
wherein the checking position corresponds to a relative position of the machining components set with the at least one machine axis,
and in that, on order to check a respective checking position for collisions, the relative position of the machining components is reproduced,
wherein one or more substitute machining components are used during the reproducing, which each are a replica or partial replica of the corresponding machining component, wherein the one or more substitute machining components comprise a substitute workpiece which is a partial replica of the workpiece, wherein in the substitute workpiece the workpiece is replicated at least over an axial partial region over only a part of a circumference of the workpiece,
and wherein, in the reproduced relative position, the substitute workpiece is rotated about its workpiece axis.

The invention provides the reproducing of relative positions of the machining components detected in the process-specific cycle that are particularly susceptible to collisions (“checking positions”), in the course of the collision checking. Here one or more substitute machining components are used in place of the original machining components, including at least one substitute machining workpiece in place of the original workpiece.

The use of substitute machining components makes it possible, on the one hand, during the collision check to protect corresponding original machining components, or components that may collide with the substitute machining components, from damage. Substitute machining components are generally made of a low-cost and flexible material (preferably elastically or also plastically easily deformable material). In the case of collisions during the collision check, only the substitute machining component or the substitute machining components are deformed, which does not represent any damage or at least any significant damage, but no damage occurs to other components, for example the machine tool or a model of the machine tool. Typical materials for substitute machining components are plastic, sheet metal (preferably with a sheet thickness of approximately 2 mm, or also a sheet thickness between 1 mm and 3 mm) or cardboard.

On the other hand, the invention provides that the substitute workpiece is formed not as a complete replica of the original workpiece, but as a partial replica of the original workpiece. At least in an axial section of the workpiece, the workpiece is replicated by the substitute workpiece over only a part of the circumference. In other words, part of the circumference of the workpiece is omitted in the replica, at least in the axial partial region; typically, at least ⅓ of the circumference of the workpiece is omitted in the replica (at least in the axial partial region) in the substitute workpiece.

This can provide an operator with a fundamentally better view of the machining components and substitute machining components, and any collisions can be more easily detected. In particular, in the case of internally toothed workpieces, it is possible to view the radial interior of the workpiece on the substitute workpiece, which would not be possible with the original workpiece. However, by rotating the substitute workpiece (typically by hand by an operator), it remains possible to check for collisions over the full circumference of the workpiece (and, in particular, the parts of the circumference of the workpiece not replicated in the substitute workpiece) using the substitute workpiece.

Typically, a toothing of the workpiece is also replicated only over a part of the circumference. In this case, during the collision check the tool or substitute tool can simulate its full infeed and full feed during the collision check relative to the substitute workpiece by placing the substitute workpiece in a rotational position in which the tool or substitute tool engages a non-replication part of the circumference on the substitute workpiece. By rotating the substitute workpiece up to the tool or substitute tool, it can nevertheless easily be estimated whether or not a collision will occur. Note that it is also possible, alternatively or additionally, to replicate toothings of the workpiece at least locally on the substitute workpiece by an envelope curve or envelope surface corresponding to the root circle of the toothing, which also allows simulation of a complete infeed and feed. In general, the tool and the workpiece are rotationally symmetrical (with a counting symmetry corresponding to the number of teeth of their toothing).

It can be provided to replicate the workpiece over its entire axial extension over only part of its circumference with the substitute workpiece, which can optimize the operator's view. However, it is also possible to limit the omission of part of the circumference in the replica to an axial partial region that is particularly important for a good view.

Note that, beyond the substitute workpiece, further substitute machining components can also replicate the respective associated machining component at least over an axial partial region over only part of its circumference or also over its entire circumference. Preferably, in addition to the workpiece, a clamping means for the workpiece and/or the tool are also replicated by means of substitute machining components and are used in the reproducing of the checking positions.

Typical machining components are (in addition to the workpiece and the tool) a clamping means for the workpiece, a tool holder for the tool, workpiece-specific tooling (also called auxiliary tooling, in particular, one or more gas nozzles for blowing away chips, one or more suction nozzles for extracting chips, one or more coolant lubricant nozzles for dispensing cooling lubricant, one or more centering sensors), a workpiece spindle or a tool spindle.

In the case of three-dimensional substitute machining components, for example, these can be produced by 3D printing (usually from plastic); in principle, however, any manufacturing processes can be considered. Two-dimensional substitute machining components (“templates”) are preferably cut from flat material (for example cardboard or sheet metal), e.g., by laser or waterjet cutting.

Typical checking positions are the beginning or end of engagement of workpiece and tool during machining, or locations of a change of direction of machining components, as well as movement end points of machining components. Note that, within the scope of the method according to the invention, the checking positions can be approached manually, semi-automatically, or also automatically.

The machine tool is typically a gear cutting machine, in particular, a hob peeling machine, e.g., a hard hob peeling machine, or a gear grinding machine, e.g., a generating grinding machine or profile grinding machine, or a honing machine or a gear hobbing machine. Machine axes used in the process-specific cycle can be, in particular, linear axes or rotary axes.

If the collision checking yields the conclusion that there are no unintentional collisions of the machining components in the intended process-specific cycle, the machining process can be started on the machine tool (with all original machining components). If the collision checking reveals unintended collisions of the machining components, the intended process-specific cycle is modified to avoid the collisions. As a rule, a collision check is then carried out again for the modified process-specific cycle before the machining process is started.

### Preferred Variants of the Invention

In an advantageous variant of the method according to the invention, the reproducing of the relative position of the machining components is carried out on a model of the machine tool separate from the machine tool. This allows a collision check (for example for a machining process to be set up next) to be performed without interrupting production at the machine tool (according to a previous machining process). The machine axes of the machine tool are typically replicated in the model without motorization.

An alternative variant is preferred in which the reproducing of the relative positions of the machining components takes place on the machine tool. The effort for the provision of a model of the machine tool is eliminated. In addition, original machining components, or also motorized machine axes on the machine tool, can easily be used in the collision check. In principle, all structures of the machine tool can be taken into account during the collision check, without any structure being forgotten. In this variant, the one or more substitute machining components are attached to the machine tool, preferably by means of magnets and/or screw fittings and/or other fasteners. Remaining (not substituted) machining components are permanently present in the machine tool or are mounted in the original.

A further development of this variant is preferred in which the machine tool has at least one workpiece spindle with at least one clamping means and the substitute workpiece is mounted with the clamping means for the reproducing. By using the original clamping means on a workpiece spindle of the machine tool, the fastening of the substitute workpiece for the collision check is particularly simple. If the machine tool has multiple workpiece spindles, a substitute workpiece can be mounted on one or on a plurality of the workpiece spindles with the respective clamping means there.

A further development of the above variant is advantageous wherein the substitute workpiece is fastened to an intermediate holder for the reproducing, and the intermediate holder is fastened directly or indirectly to the workpiece spindle, in particular, wherein the intermediate holder is fastened to the workpiece spindle with a clamping means of the workpiece spindle. The intermediate holder simplifies the fastening of the substitute workpiece to the original workpiece spindle. The substitute workpiece does not have to be attachable directly to the original clamping means or directly to the original workpiece spindle. The intermediate holder can serve as a fastening mediating piece between the substitute workpiece and the workpiece spindle or the clamping means, and can be matched to the substitute workpiece at one end and at the other end to the workpiece spindle or the clamping means. The intermediate holder can be designed for a rotationally fixed fastening of the substitute workpiece to the workpiece spindle (so that the rotatability of the substitute workpiece is set up only via the workpiece spindle), or the intermediate holder can form a separate rotary bearing (as a result of which the intermediate holder then serves simultaneously as an auxiliary rotating holder; see also below).

In a preferred further development of the above variant, the substitute workpiece is fastened to a workpiece spindle of the machine tool for the reproducing, and the workpiece spindle of the machine tool is rotated to rotate the substitute workpiece about its workpiece axis. The use of the rotary bearing of the workpiece spindle for rotating the substitute workpiece is particularly constructively simple. The rotation of the substitute workpiece on the workpiece spindle can be done manually or motorized (slowly, usually step-by-step).

In an advantageous variant, it is provided that for reproducing, the substitute workpiece is mounted on an auxiliary rotary holder, and that for rotation of the substitute workpiece it is rotated on the auxiliary rotary holder. This means that the workpiece spindle of the machine tool or its rotary bearing does not have to be used to turn the substitute workpiece, which can be quite cumbersome if done manually or quite time-consuming in terms of programming and safe operation if done in motorized fashion. The auxiliary rotary holder forms a separate rotary bearing for rotating the substitute workpiece. The rotary bearing of the auxiliary rotary holder can be designed, in particular, as a plain bearing or as a rolling bearing. The auxiliary rotary holder comprises two components that can be rotated relative to each other, a first component of which directly or indirectly holds the substitute workpiece; the second component thereof can, for example, be directly or indirectly attached to the original workpiece spindle or to the original clamping means, or can also be attached to a corresponding structure of a model (the second component is then, for example, a sliding base or a rotary plate), or the second component is formed by a part of the outer contour of the original workpiece spindle or of the original clamping means, on which part of the outer contour the first component can slide while rotating. In a subvariant, a separate second component (for example a “ring” component) is formed at one end to correspond to the clamping contour of the workpiece and, at the other end, to correspond to a part of the outer contour of the workpiece spindle, and the first component is formed for rotational sliding on this part of the outer contour of the workpiece spindle; the first component can then form an auxiliary rotary holder optionally with the separate second component (which is arranged on the original clamping means) or with the part of the outer contour of the original workpiece spindle as second component. The auxiliary rotary holder is typically rotated manually. The auxiliary rotary holder is principally not part of the machine tool. Of course, the axis of rotation of the auxiliary rotary holder is coaxially aligned with the workpiece axis as determined by the workpiece spindle.

In a preferred embodiment, it is provided that the substitute workpiece has an axial partial region in which the workpiece is replicated only over a part of a circumference of the workpiece, and has an axial residual region in which the workpiece is replicated over its full circumference, in particular, wherein in the axial partial region the part of the circumference has multiple substructures separate from one another in the circumferential direction. With the residual region, the substitute workpiece can be fastened like the workpiece, for example in an original clamping means. By opening the substitute workpiece in the axial partial region over part of the circumference, the operator's view can be improved, especially in the case of an internally toothed workpiece. With the separate substructures, for example two substructures at a distance of approximately 180° or three substructures at a distance of approximately 120°, a particularly good view can be obtained. If desired, the substructures can also assist in clamping the substitute workpiece (e.g., with jaw chucks or swivel claw chucks). The substructures usually extend in the circumferential direction over only a small angular range, usually 30° or less, in particular, 20° or less.

A variant is further preferred in which the substitute workpiece is designed as a partial workpiece which replicates the workpiece at least in an axial partial region over at least ⅓ of its circumference and at most ⅔ of its circumference, in particular, wherein the partial workpiece is designed as a half-workpiece. With such a partial workpiece, the collision situation can be displayed particularly clearly for an operator and can be grasped particularly easily and quickly by the operator. The substitute workpiece usually only needs to be rotated slightly during the collision check. In the partial workpiece, the replicated part of the circumference of the workpiece is typically contiguous in the circumferential direction.

A variant is preferred in which the substitute workpiece only replicates a cross-sectional contour of the workpiece completely or partially. As a result, the manufacture of the substitute workpiece is particularly simple. The cross-section is taken here in a plane that contains the workpiece axis.

In a particularly preferred development of this variant, the substitute workpiece is formed by a two-dimensional template. The production of a two-dimensional template is particularly simple and cost-effective. In addition, a particularly good view is provided for the operator. In particular, the template can be designed as a half-template, which replicates only one half of the cross-sectional contour on one side of the workpiece axis (completely or partially). Likewise, the template can also be designed as a full template that replicates both halves of the cross-sectional contour on both sides of the workpiece axis (completely or partially). The template is typically mounted with a template holder on the machine tool (directly or indirectly on the workpiece spindle) or on the model of the machine tool.

In an advantageous subvariant of this further development, it is provided that the two-dimensional template is designed as a multiple template which, at different sections of its edge contour, replicates the cross-sectional contours of different workpieces, in each case completely or partially. This allows a large number of workpieces to be replicated and checked for collisions in a simple and cost-effective manner using just one template. By mounting the multiple template in a specific orientation, a specific section of the edge contour and thus a specific workpiece can be selected for the collision check. A typical multiple template is formed with two to eight different sections, each corresponding to the cross-sectional contour of a different workpiece.

In addition, a subvariant of the above further development is advantageous in which the two-dimensional template has partial segments that are adjustable relative to one another and which are set in such a way that they completely or partially replicate the cross-sectional contour of the workpiece and/or of a clamping means. By means of the adjustable partial segments, the two-dimensional template can be used universally for practically any workpieces and, if desired, also for clamping means the respective cross-sectional contour of which is set on the adjustable partial segments. Typically, the partial segments have a diameter or largest edge length in cross-section perpendicular to their direction of extension of 2 mm or less, usually 1 mm or less.

A further development of the above variant is also advantageous in which the substitute workpiece completely or partially replicates the cross-sectional contour of the workpiece and/or of a clamping means using light beams, in particular, laser beams. Light beams eliminate any risk of damage that could occur during the collision check. In addition, collisions are often particularly easy for an operator to detect by means of light beams. As a rule, a set of light beam sources (such as laser diodes on magnetic holders) can also be used to easily replicate a large number of cross-sectional contours of different workpieces and, if desired, clamping means as well, so that this procedure can be used universally. The light rays have a wavelength or wavelength spectrum in the visible spectral range; the light rays are preferably selected with an intensity that is not dangerous to the human eye. Typically, at least three light beams are used simultaneously (e.g., at least two light beams horizontally, at least one light beam vertically). Alternatively, a partial replica of the cross-sectional contour can also be made using rods, strings or wires instead of light beams. Further alternatively, it is also possible to produce the substitute workpiece by holography.

A subvariant of this further development is preferred which provides that the light beams replicate edges of the cross-sectional contour of the workpiece and/or of the clamping means, and/or that intersection points of the light beams replicate corner points in the cross-sectional contour of the workpiece and/or the clamping means. For example, horizontal light beams can reproduce a workpiece top edge and the bottom of a blind hole in the clamping means, and one or more vertical light beams can reproduce an inside diameter of the workpiece or clamping means. This procedure has proven successful in practice for the discovery of collisions. If, in a single constellation of the available light beam sources, not all relevant edges and corner points of the cross-sectional contour can be checked for collision, multiple constellations of light beam sources per relative (checking) position can also be set up in succession and checked for collisions.

In a preferred variant, the one or more substitute machining components comprise a substitute tool that is a replica or partial replica of the tool. In this way, damage to the original tool by the collision checking can be completely ruled out. In addition, if desired, the original tool can still be used for other purposes during the collision checking or does not yet need to be manufactured for the collision checking. The substitute tool can be manufactured for example by 3D printing. By 3D printing, complex tools can also be replicated with comparatively little effort (in particular, when a toothing of the tool is to be completely replicated). The substitute tool can also be manufactured by processes other than 3D printing, such as turning and/or milling. Typically, teeth of the tool are omitted during the (partial) replication or are replaced by envelope curves or envelope surfaces.

A further development of this variant is preferred which provides that the substitute tool is a partial replica of the tool, wherein in the substitute tool the tool, at least over an axial partial region, is replicated only over a part of a circumference of the tool, and that in the reproduced relative position the substitute tool is rotated about its tool axis. In this way, in turn an operator's view of the collision situation can be improved. By rotating the substitute tool, those parts of the circumference of the tool that were not replicated in the substitute tool can also be checked for collisions. The partial replication of the tool can take place analogously to the partial replication of the workpiece, in particular, by means of a two-dimensional template.

Also preferred is a further development in which the one or more substitute machining components comprise a substitute tool holder that is a replica or partial replica of a tool holder with which the tool is to be held on a tool spindle of the machine tool. Accordingly, the tool holder is also fully protected from damage during the collision check, and possibly the operator's view can also be improved with regard to the tool holder.

A variant is also advantageous in which the one or more substitute machining components comprise a substitute clamping means which is a replica or partial replica of a clamping means with which the workpiece is to be held on a workpiece spindle of the machine tool. This makes it possible to exclude or minimize damage to the clamping means, or by the clamping means, during the collision check. The operator's view with regard to the clamping means may also be improved.

In a preferred further development of this variant, the substitute clamping means is rotated in the reproduced relative position together with the substitute workpiece, in particular, wherein the substitute clamping means and the substitute workpiece are formed by a common two-dimensional template. This is particularly simple to set up. The substitute clamping means can be mounted, for example, on an auxiliary rotary holder or also on the workpiece spindle.

Particularly preferred is a variant which provides that, in the case of one or more substitute machining components, a toothing of the corresponding machining component is replaced completely or partially by an envelope curve or envelope surface of the toothing. This significantly simplifies the production of the substitute machining component. The envelope curve or envelope surface can run, in particular, on a tip circle or root circle of the toothing. By replication at the tip circle, the collision of the gearing with (typically non-geared) structures of other machining components can be checked. By replication at the root circle, it can be ensured that a mutual engagement of two toothings does not block the reproducing of an associated checking position.

Furthermore, a variant is advantageous in which the machining components comprise at least one auxiliary tool, in particular, wherein the at least one auxiliary tool comprises a gas nozzle arrangement and/or a suction nozzle arrangement and/or a lubricant coolant nozzle arrangement and/or a centering sensor. The auxiliary tool or tools are also referred to as supplementary tools. The at least one auxiliary tool serves to support the immediate machining of the workpiece by the tool before or during the processing; the auxiliary tool itself is typically not used for the immediate machining of the workpiece. When the relative position of the machining components is reproduced, the original auxiliary tool of the machine tool is typically used; however, it is also possible to use substitute auxiliary tools. By taking the auxiliary tool into account in the collision check, unintentional collisions in which the auxiliary tool is involved can also be detected, thus possibly preventing damage.

A further development of this variant is preferred which provides that, for at least one checking position, in the reproduced relative position, a functional optimization of the at least one auxiliary tool takes place, in particular, by positioning, alignment and/or selection of the auxiliary tool. Due to the only partial replication of the workpiece by the substitute workpiece and, if applicable, further machining components by substitute machining components, auxiliary tools are easily visible and easily accessible so that the optimization of the auxiliary tools, in particular, their positioning and alignment, can be carried out particularly easily during the collision check. For example, blowing nozzles can be directed particularly precisely to the location where chips are produced, or to locations of any accumulation of chips.

Particularly preferred is a variant in which the workpiece, which is partially replicated by the substitute workpiece, is an internally toothed workpiece. In the case of an internally toothed workpiece, it is particularly difficult to visually check collisions conventionally, since the workpiece practically completely covers the toothing to be machined and further internal structures. If a partial replication of the workpiece is used as a substitute workpiece according to the invention, the view into the workpiece can be significantly improved, since the substitute workpiece is opened at least over a part of the circumference of the workpiece. The invention is therefore particularly useful for internally toothed workpieces. Alternatively, the invention can also be used for example for externally toothed workpieces or spur-toothed workpieces. In general, a workpiece which is checked for collisions within the scope of the invention can have one or more toothings.

Furthermore, a variant is preferred in which at least one light gap is observed for collision checking during rotation of the substitute workpiece. At least one of the light gaps can run between the substitute workpiece and the tool or substitute tool. If the light gap disappears or falls below a specified size, a collision is detected. Alternatively, the collision can be detected on the basis of an increased rotational resistance or on the basis of a deflection, in particular, of the substitute workpiece and/or the tool or substitute tool.

Further preferred is a variant which provides that at least one substitute machining component has a first replication section and a second replication section, wherein these replication sections replicate two similarly formed sections of the corresponding machining component, and wherein a type of replication in the first replication section and in the second replication section is different, in particular, wherein the similar sections on the machining component bear a toothing, and the first replication section replicates a tip circle of the toothing, and the second replication section replicates a root circle of the toothing. The different type of replication may consist, in particular, in replicating in one of the replications a largest radial and/or axial extension of a structure (periodic in the circumferential direction) of the similar sections, and in replicating in the other of the replications this structure a smallest radial and/or axial extension of the structure (periodic in the circumferential direction). With this variant, it is possible both to detect immediate collisions of, for example, the toothing (in particular, by means of the first replication section) and to replicate a fully infed/fed relative position, in which, for example, the toothing meshes with another toothing of another machining component. The similar sections of the machining component can be transformed into each other by rotation (e.g., around the workpiece axis in the case of a substitute workpiece).

Also advantageous is a variant in which at least one boundary marking is applied to at least one substitute machining component, said boundary marking indicating the boundary of a structure of the associated machining component that is not, or not completely, replicated on the substitute machining component. By way of example, the boundary marking can indicate the start or the end of a toothing, which at least locally is not, or not completely, replicated on the substitute machining component. The boundary markings allow an operator to more easily detect a collision in the area of structures that are not replicated or are not fully replicated. A structure that is not replicated, or not fully replicated, can enable a fully infed and/or fully fed relative position of substitute machining components and machining components to be set that would not be settable with fully replicated structure.

In an advantageous variant, it is provided that an identification marking is applied to at least one substitute machining component, which identification marking enables an identification of the substitute machining component and/or an assignment of the substitute machining component to the corresponding machining component, in particular, wherein the identification marking is readable by a person with the naked eye and/or machine-readable, and, in particular, wherein the identification marking comprises an alphanumeric code and/or a QR code and/or a bar code and/or an RFID tag. This simplifies the handling of the machine tool and its substitute machining components and the performance of the method according to the invention, in particular, also in an automated sequence. The identification marking can, for example, be printed or glued on or engraved.

The scope of the present invention also covers a machine tool system designed to carry out an above-described method according to the invention, the machine tool system comprising a machine tool for machining at least one workpiece and comprising one or more substitute machining components, each of which is a replica or partial replica of a corresponding machining component of the machine tool, wherein the one or more substitute machining components comprise a substitute workpiece which is a partial replica of the workpiece, wherein in the substitute workpiece the workpiece, at least over an axial partial region, is replicated only over a part of a circumference of the workpiece. With the machine tool system according to the invention, a collision check can be carried out in a simple, cost-effective and secure manner, in particular, using an above-described method according to the invention. The machine tool system can also comprise one or more additional substitute machining components (in addition to the substitute workpiece), for example a substitute tool or a substitute clamping means or a substitute tool holder. With respect to one or more machining components, the machine tool system can comprise both an original machining component and a substitute machining component (for example an original clamping means for the workpiece and the associated substitute clamping means).

In a preferred embodiment of the machine tool system according to the invention, it is provided that the machine tool comprises an electronic machine controller which is programmed, for carrying out the above-described method according to the invention, to approach for all identified checking positions associated relative checking positions of the substitute machining components and/or machining components arranged on the machine tool, in particular, wherein the relative checking positions are equal to the relative positions of the machining components in the process-specific cycle or the relative checking positions correspond to the relative positions of the machining components in the process-specific cycle plus an offset which is caused by a fastening of a respective substitute machining component on the machine tool differing from a fastening of a corresponding original machining component. Carrying out the method according to the invention for collision checking is thereby possible in a particularly simple and comfortable manner on the machine tool.

Also within the scope of the present invention is the use of a substitute machining component in a method described above according to the invention or in a machine tool system described above according to the invention, wherein the substitute machining component is a replica or partial replica of a corresponding machining component, in particular, wherein the substitute machining component is a substitute workpiece for a corresponding workpiece, wherein in the substitute workpiece the workpiece, at least over an axial partial region, is replicated only over a part of a circumference of the workpiece. By means of this use, collision checks are possible in a simple, cost-effective and secure manner.

Further advantages of the invention can be found in the description and the drawings. The embodiments shown and described are not to be understood as an exhaustive list, but, rather, have an exemplary character for the description of the invention.

### BRIEF DESCRIPTION OF THE DRAWINGS

FIG. 1 shows, in a schematic side view, an exemplary embodiment of a machine tool system according to the invention for carrying out the method according to the invention for collision checking, with a mounted substitute workpiece which is designed as a half-workpiece;

FIG. 2 shows an enlargement from FIG. 1 in the region of the substitute workpiece;

FIG. 3 shows, in a schematic perspective view, the half-workpiece from FIG. 1;

FIG. 4 shows, in a schematic perspective view, an exemplary substitute workpiece which is formed with three partial structures spaced apart in the circumferential direction, for the invention;

FIG. 5 shows, in a schematic perspective view, an original workpiece of the substitute workpieces of FIGS. 3 and 4;

FIG. 6 shows, in a schematic perspective view, the clamping means from FIG. 1 with the substitute workpiece mounted thereon;

FIG. 7 shows, in a schematic perspective isolated view, the substitute tool holder with mounted substitute tool of FIG. 1, wherein a toothing of the original tool is replicated by an envelope surface;

FIG. 8a shows, in a schematic perspective view, an exemplary substitute tool holder with substitute tool, in which a toothing of the original tool is completely replicated, for the invention;

FIG. 8b shows, in a schematic perspective view, an exemplary substitute tool holder with substitute tool which is designed as a two-dimensional template, for the invention;

FIG. 9 shows, in a schematic perspective view, a further exemplary embodiment of a machine tool system according to the invention for carrying out the method according to the invention for collision checking, with a mounted two-dimensional template that forms a substitute workpiece and a substitute clamping means;

FIG. 10 shows an enlargement from FIG. 9 in the region of the two-dimensional template;

FIG. 11 shows, in an enlarged lateral plan view, the two-dimensional template of FIG. 9;

FIG. 12 shows, in a schematic perspective view obliquely from above, a template holder of an intermediate holder with a mounted multiple template, for the invention;

FIG. 13 shows the template holder and the multiple template of FIG. 12 in a schematic, perspective view obliquely from below;

FIG. 14a shows, in a schematic perspective view obliquely from above, an exemplary intermediate holder designed as an auxiliary rotary holder with a plain bearing, for the invention;

FIG. 14b shows, in a schematic perspective view obliquely from below, the intermediate holder of FIG. 14a;

FIG. 14c shows, in a schematic cross-section, an exemplary intermediate holder, which is designed as an auxiliary rotary holder with a roller bearing, for the invention;

FIG. 15 shows, in a schematic sectional view, a substitute workpiece which is designed as a two-dimensional template with adjustable partial segments, for the invention;

FIG. 16 shows, in a schematic perspective view, a detail of a further exemplary embodiment of a machine tool system according to the invention, for carrying out the method according to the invention for collision checking, with a substitute workpiece which partially replicates the original workpiece using light beams;

FIG. 17 shows, in a schematic perspective view, a model which replicates the machine axes of a machine tool, for carrying out the method according to the invention for collision checking in a further variant.

### DETAILED DESCRIPTION OF EMBODIMENTS OF THE INVENTION

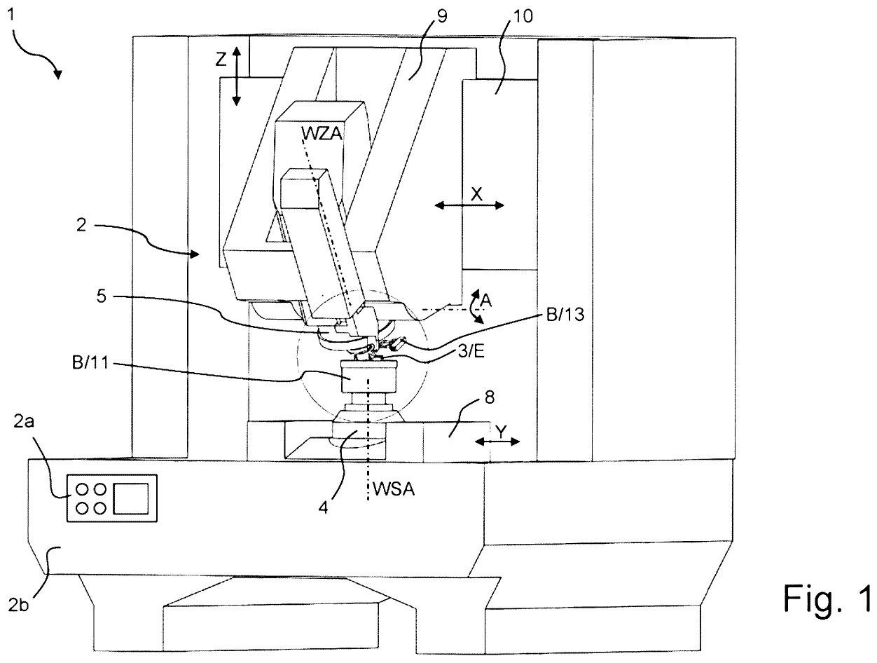

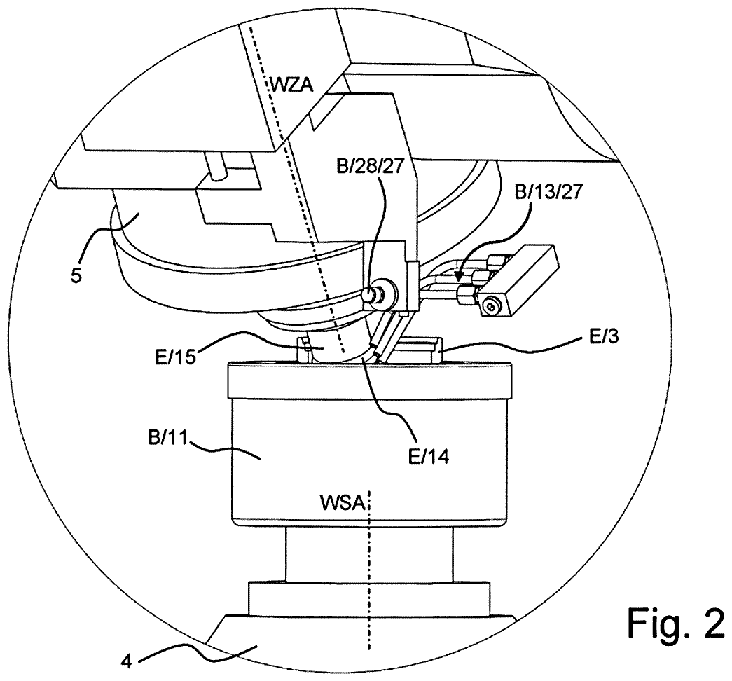

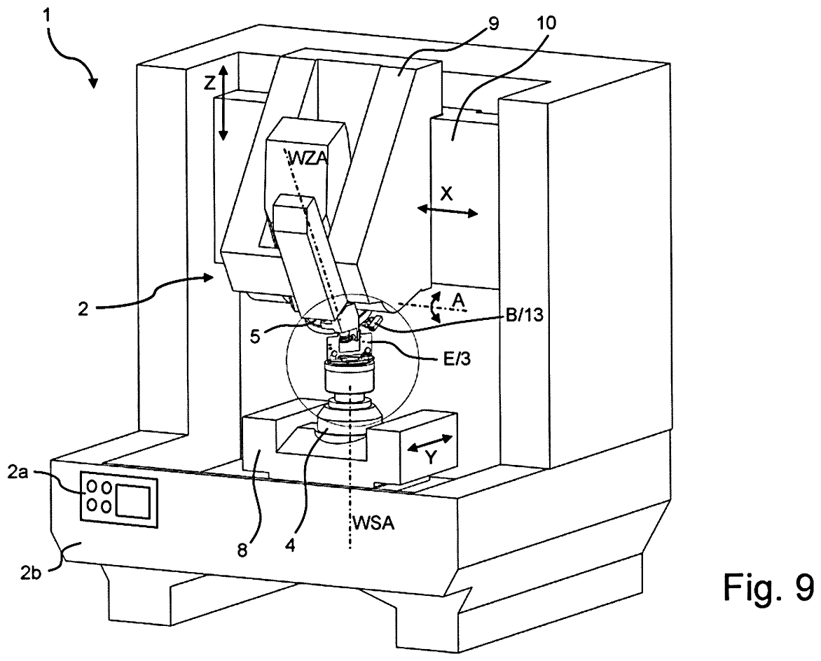

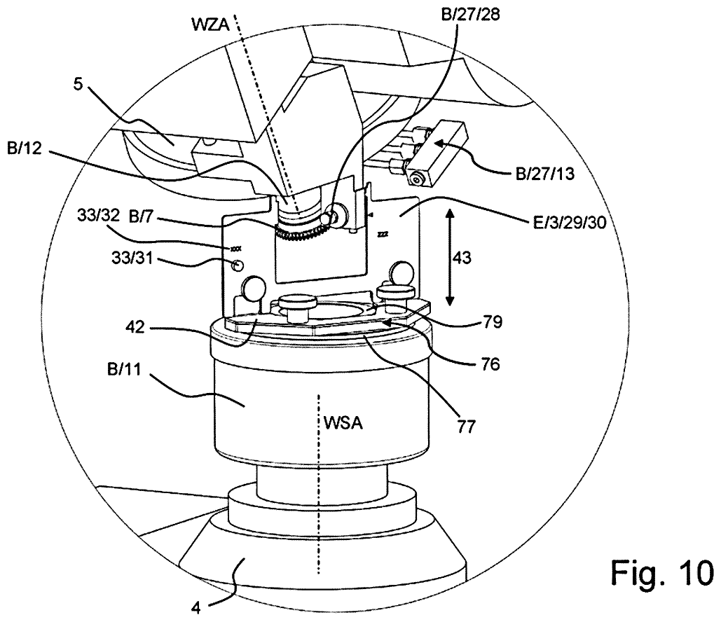

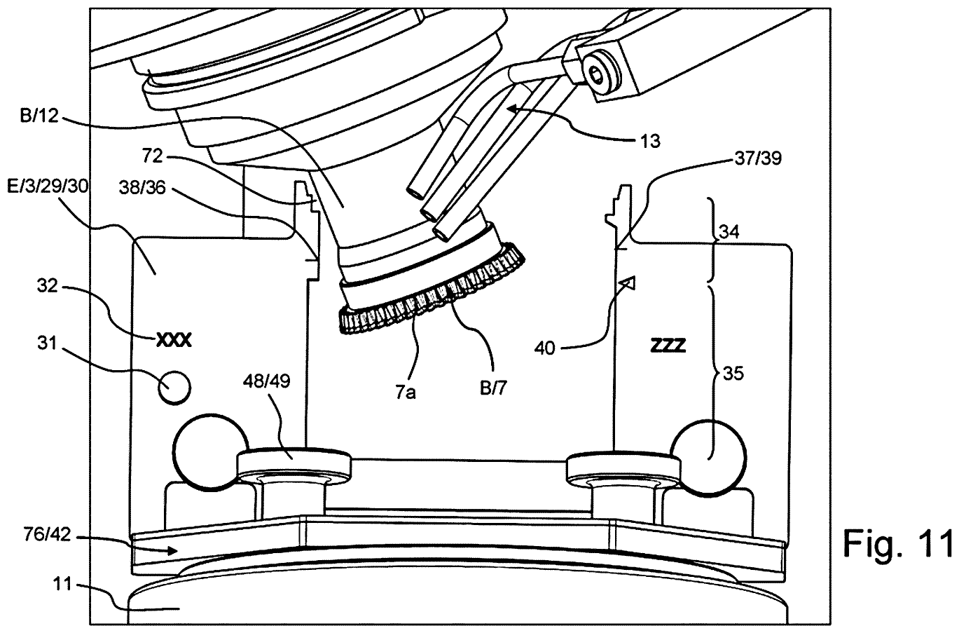

FIG. 1 shows an exemplary embodiment of a machine tool system 1 according to the invention in a schematic side view, for carrying out the method according to the invention for collision checking, in an exemplary variant. The machine tool system 1 has a machine tool 2 on which a substitute workpiece 3 is mounted. FIG. 2 shows an enlarged detail of FIG. 1 in the region of the substitute workpiece 3. Note that FIG. 9 shows another similar embodiment of a machine tool system 1, and the general statements relating to the machine tool 2 apply equally to both embodiments. FIG. 10 shows an enlarged section of FIG. 9 in the area of the substitute workpiece 3 there, and FIG. 11 another enlarged side view of the substitute workpiece 3 of FIG. 9.

A machining process is planned on the machine tool 2, during which a workpiece (not shown in FIG. 1/FIG. 2 and FIG. 9/FIG. 10/FIG. 11, but cf. FIG. 5, ref. 20) mounted on the machine tool 2 is to be subjected to machining with a tool (not shown in FIG. 1/FIG. 2, but cf. the substitute tool 14 shown in FIG. 7 and the tool ref. 7 in FIG. 10), for example a hard hob peeling. The workpiece is here rotated about a workpiece axis WSA of a workpiece spindle 4 (C axis of the machine tool 2) and the tool is rotated about a tool axis WZA of a tool spindle 5 (B axis of the machine tool), and the workpiece and the tool are brought into engagement with each other. Typically, a plurality of workpieces are to be machined in succession so that first the workpiece is mounted on the machine tool, is machined, and is dismounted, and then the next workpiece is mounted, machined, and dismounted, and so on.

In the course of machining a single workpiece, machining components B are moved relative to each other on the machine tool 2 by means of machine axes in a process-specific cycle; the process-specific cycle is repeated each time a new workpiece is machined. Machining components B of the machine tool 2 here represent at least the workpiece and the tool. The machine tool 2 here comprises, by way of example, as machine axes which can be actuated in the context of a process-specific cycle:
a machine axis Y with which a workpiece slide 8 can be moved here in a horizontal direction relative to a machine bed 2b of the machine tool 2, wherein the workpiece slide 8 carries the workpiece spindle 4;
a machine axis X, with which a tool slide 9 can be moved here in a horizontal direction relative to a cross-slide 10, wherein the tool slide 9 carries the tool spindle 5;
a machine axis Z, with which a cross-slide 10 can be moved here in a vertical direction relative to the machine bed 2b, the cross-slide 10 carrying the tool slide 9;
a machine axis A about which the tool spindle 5 can be pivoted on the tool slide 9, wherein the machine axis A here extends horizontally (i.e., parallel to X).

The machine axes X, Y, and Z are orthogonal to one another here. The machine tool 2 can be designed, and, in particular, can have a design of machine axes, as described in CH 715 794 B1. The entire content of CH 715 794 B1 is hereby incorporated by reference into the present disclosure.

As can be seen on the substitute workpiece 3, the workpiece is selected as an internally toothed workpiece in the example shown (cf. also FIG. 5). In the context of a process-specific cycle, for example an actuation sequence of the machine axes X, Y, Z could be provided as follows with steps S1 to S7 (where it is assumed that the workpiece is initially at a workpiece change position and the tool is initially in a position for the workpiece change, in which the tool deviates from a base position in the X and Z directions):
S1: Move workpiece slide 8 via Y to move the workpiece from the workpiece change position to the machining position;
S2: Move tool slide 9 via X and cross slide 10 via Z to bring the tool into the base position;
S3: Starting from the base position of the tool, move the cross slide 10 downwards via Z so that the tool performs a machining on the workpiece (feed);
S4: Adjust the tool slide 9 via X and, if required, coupled with a movement of the workpiece slide 8 in Y, in order to disengage the workpiece and tool;
S5: Move the cross slide 10 upwards via Z to move the tool out of the workpiece;
S6: Move tool slide 9 via X and, if not yet done in step S4, cross slide 10 via Z until the tool is again in the position for the workpiece change;
S7: Move workpiece slide 8 via Y to move the workpiece back to the workpiece change position.

Between steps S7 and S1, a workpiece change can be carried out; for this purpose, for example, a workpiece changing robot not shown in more detail can be used. At least during steps S3 and S4, the tool and the workpiece rotate (actuation of the B axis and the C axis, but these are generally not relevant for the collision check). In the above example, the machine axes X, Y, Z are predominantly or consistently actuated individually one after the other, which is often preferred; however, it is also possible to actuate multiple machine axes X, Y, Z simultaneously at least at times. Note also that the machine axes actuated in the cyclic process need not be linear axes, and in particular, may also include pivot axes. Furthermore, the machine axes can comprise redundant axes.

When planning a process-specific cycle, it must be checked (before the process-specific cycle is executed for the first time as part of an actual workpiece machining) whether the planned cycle is free of unintentional collisions between the machining components involved (“collision checking”). If yes, the machining can be started. If no, the previously planned process-specific cycle must be modified. The present invention provides for the following procedure for the collision checking.

First, one or more checking positions are identified (determined) in the planned process-specific cycle; this identification can be performed by an electronic control unit that knows the planned process-specific cycle. A checking position in each case describes the relative position (including the orientations) of the machining components participating in the machining process, thus a checking position corresponds to a point in time in the process-specific cycle. In principle, the checking positions are determined in such a way (in particular, in selection and number) that, in the event of an absence of collisions at all provided checking positions, the process-specific cycle is collision-free overall.

In many cases, the points in time in the process-specific cycle at which the actuation of a machine axis has ended and/or the actuation of the next machine axis will begin (“change of direction”) are well suited as checking positions. If necessary, these checking positions can be supplemented by further checking positions, for example in the case of relative positions of the machining components at which the greatest proximity of two machining components is expected (for example if two machining components or protruding parts thereof are at “the same height” with respect to the direction of a machine axis). For example, in the above example, the checking positions can be set in each case at the ends of steps S2-S4.

The relative position of the machining components involved is then reproduced for each intended checking position. In this context, one or more original machining components B are replaced within the scope of the invention by substitute machining components E which are a replica or partial replica of the associated original machining component B; at least the workpiece is replaced by a substitute workpiece 3. The substitute workpiece 3 replicates the workpiece (at least in an axial partial region) over only a part of its circumference; that is, part of the circumference is omitted. This can provide an operator with a better view of the collision situation, especially into the radial interior of the substitute workpiece 3. By rotating the substitute workpiece 3, the full circumference of the substitute workpiece 3 or workpiece can still be checked for collisions. In particular, when the replicated part of the circumference is rotated, it can be brought into a collision-critical position without the rotational position belonging to the collision-critical position having to be previously known or set in advance.

In the machine tool shown in FIG. 1/FIG. 2, as machining components B in the machining process the workpiece, a clamping means 11 for the workpiece, the tool, a tool holder (cf. ref. 12 in FIG. 9/FIG. 10/FIG. 11) for the tool, a gas nozzle arrangement 13 and a centering sensor 28 are provided. Some of the machining components B were replaced by substitute machining components E for the collision test; in the machine tool system 1 used for the collision checking according to the invention, in the embodiment of FIG. 1/FIG. 2, the workpiece is replaced by the substitute workpiece 3, the tool by a substitute tool 14 and the tool holder by a substitute tool holder 15. The substitute machining components E are generally made of a low-cost and flexible material so that, in the event of a collision during the collision check, a (original) machining component B involved in the collision is not damaged by a substitute component E.

In the embodiment shown in FIG. 1, the relative positions assigned to the checking positions are directly approached as relative checking positions with the machine tool 2, since the substitute machining components E are attached here in the same way to the machine tool 2 as the corresponding original machining components B would be. An electronic machine controller 2a is programmed to move to the relative checking positions sequentially; typically, an operator manually releases the transition to a next relative checking position. At a respective relative checking position, the machine tool 2 stops, the operator opens a machine cover (e.g., a front door) and the operator, typically with his bare hand, rotates the substitute workpiece 3, in FIG. 1 by means of the workpiece spindle 4, about the workpiece axis WSA to check the collision situation. When the relative checking position has been checked, the operator closes the machine cover again, and the next relative checking position can be approached, and so forth.

In the shown embodiment of FIG. 1/FIG. 2, the gas nozzle arrangement 13 and the centering sensor 28 are also provided as machining components B, which are here fastened to a housing of the tool spindle 5. The gas nozzle arrangement 13 and the centering sensor 28 are examples of auxiliary tools 27 which support the machining of the workpiece without themselves taking part in the machining directly. The gas nozzle arrangement 13 can be used to blow chips away from the engagement area of the workpiece and tool during machining. The gas nozzle arrangement 13 is, on the one hand, checked for collisions (in particular, for collisions with the workpiece/substitute workpiece 3 or its clamping means 11) as part of the collision check according to the invention. On the other hand, the positioning and orientation of the gas nozzle arrangement 13 (in particular, of the three associated gas outlet openings in the example shown) can be optimized, for example for the checking position at the end of step S2 and/or S3 and/or S4 in the above example. As a result of the only partial replication of the workpiece by the substitute workpiece 3, this optimization is possible in a particularly simple manner for the operator, with regard both to accessibility and also to the visibility of the gas nozzle arrangement 13 and its parts. The centering sensor 28 detects the rotational position of the tool with respect to the tool axis WZA in order to set up the synchronization of tool and workpiece.

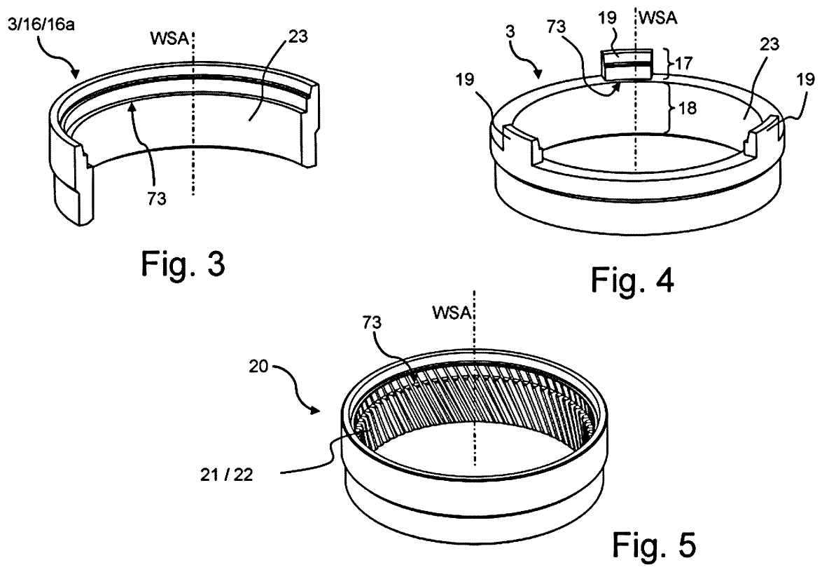

The substitute workpiece 3 used in the embodiment of FIG. 1 is shown isolated in FIG. 3. The substitute workpiece 3 is formed as a partial workpiece 16a, and here as a half-workpiece 16. In the case of the half-workpiece 16 shown, the associated original workpiece (cf. FIG. 5) is replicated contiguously over half of the circumference (i.e., 180° circumferential angle); the remainder of the circumference is omitted in the replication. The substitute workpiece 3 of FIG. 3 replicates the original workpiece over its full axial height.

To check for a collision, the half-workpiece 16 can be rotated 180° or more about the workpiece axis WSA so that the entire circumferential angle range of 360° has been occupied at least once by the half-workpiece 16.

FIG. 4 shows an alternative design of a substitute workpiece 3 which replicates the original substitute workpiece in a (here upper) axial partial region 17 over a part of its circumference, namely only by three separate partial structures 19 in the circumferential direction. The partial structures 19 are formed identically here (alternatively, it is also possible to set up two or even more replication sections on the partial structures 19 that replicate similar sections of the workpiece in different ways, not shown, but cf. FIG. 11). The partial structures 19 are spaced apart by approximately 120°. The circumferential regions between the substructures 19 (insofar as they fall within the upper axial partial region 17) are omitted in the replication in the substitute workpiece 3. In a (here lower) axial residual region 18, the original workpiece is replicated over its full circumference. The axial residual region 18 facilitates the clamping of the substitute workpiece 3 on a clamping means.

To check for a collision, the substitute workpiece 3 can be rotated by 120° or more about the workpiece axis WSA so that the entire circumferential angle range of 360° has been assumed at least once by a partial structure 19.

For comparison, FIG. 5 shows the original workpiece 20, which was partially replicated by the substitute workpieces of FIG. 3 and FIG. 4. It has a toothing 21, namely an internal toothing 22.

The toothing 21 was replaced in the substitute workpieces 3 of FIG. 3 and FIG. 4 by an envelope surface 23, which in this case replicates the tip circle of the toothing 21. As a result, the substitute workpieces 3 are easier to manufacture. Otherwise, the dimensions of the respective substitute workpiece 3 correspond to the dimensions of the original workpiece 20. It should be noted that the toothing 21 in the example shown has a step 73 which is also seen on the substitute workpieces (cf. ref. 3 in FIG. 3 and FIG. 4).

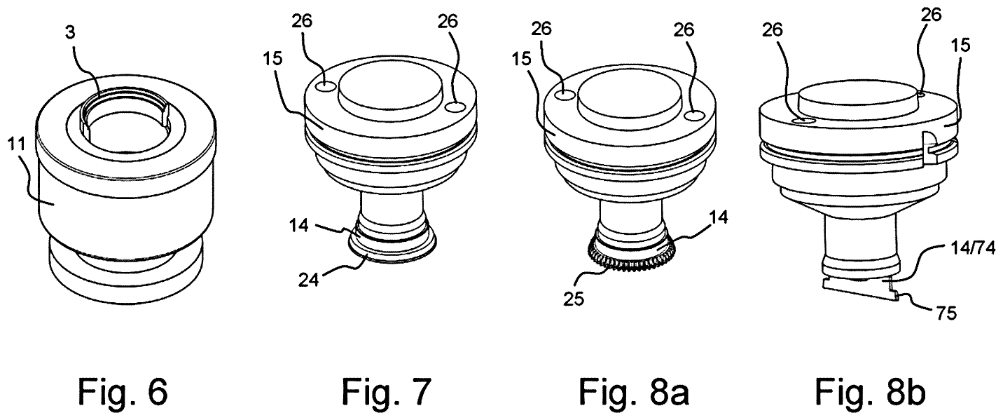

FIG. 6 shows in isolation the substitute workpiece 3 of FIG. 4 in the state clamped in the clamping means 11. The clamping means 11 can be fastened in the workpiece spindle.

FIG. 7 shows in isolation the substitute tool 14 of FIG. 1/FIG. 2 in the state fastened in the substitute tool holder 15. The substitute tool holder 15 is provided with magnets 26 with which a fastening to the tool spindle can take place in a simple manner. A toothing of the original tool was replaced by an envelope surface 24 on the substitute tool 14. Note that the substitute tool 14 is replicated here over its entire circumference. The substitute tool 14 can be manufactured for example by turning.

FIG. 8a shows an alternative configuration of a substitute tool 14 and a substitute tool holder 15 similar to the configuration of FIG. 7. However, here on the substitute tool 14 a toothing of the original tool is also completely replicated on the substitute tool 14 by a toothing 25 (i.e., tooth for tooth). The substitute tool 14 can be manufactured for example from plastic by 3D printing.

FIG. 8b shows another, alternative configuration of a substitute tool 14 and a substitute tool holder 15 similar to the configuration of FIG. 7. However, here the substitute tool 14 is formed by a two-dimensional template 74, and accordingly replicates the original tool only with respect to part of its circumference, namely in the region of a cross-section (which contains the tool axis). The toothing of the original tool is replicated on the substitute tool 14 by an envelope curve 75 corresponding to the cross-sectional contour at the tip circle of the toothing. The substitute tool 14 can be cut out from sheet metal, for example. The substitute tool 14, which is designed as a two-dimensional template 74, can be inserted for example into a slot on the underside of the substitute tool holder 15 (not shown in detail). In the collision check, the substitute tool 14 is rotated about the tool axis, here by means of the pivot bearing of the tool spindle.

FIG. 9 shows a further exemplary embodiment of a machine tool system 1 according to the invention in a schematic perspective view, for carrying out the method according to the invention for collision checking, in a further exemplary variant. FIG. 10 shows an enlargement of FIG. 9 in the area of the substitute workpiece 3, which is designed here as a two-dimensional template 30, and FIG. 11 shows an additional, enlarged plan view of the two-dimensional template 30 from the side. The machine tool system 1 has already largely been presented above in FIG. 1/FIG. 2 so that only the essential differences are to be explained here.

In FIG. 9/FIG. 10/FIG. 11, the workpiece and the clamping means for the workpiece are replaced by a substitute workpiece 3 and a substitute clamping means 29 in the machine tool system 1 which is used for the collision check according to the invention. Here the substitute workpiece 3 and the substitute clamping means 29 are formed together by a two-dimensional template 30, which, in its upper part 34, replicates the contour of the workpiece and, in a lower part 35, replicates the contour of the clamping means, partially in each case. The tool 7 with its toothing 7a and the tool holder 12 are here original machining components B. Note that alternatively also the tool 7 and the tool holder 12 can be replaced by substitute machining components, if desired (not shown in greater detail here, but cf. FIG. 7, FIG. 8a, FIG. 8b).

The two-dimensional template 30 merely replicates the cross-sectional contour of the workpiece and the clamping means (in a part relevant for the collision check). This is very simple and low-cost to manufacture, for example by punching or cutting out from a plastic plate, cardboard plate, or thin sheet metal. On the other hand, a very good view of the collision situation is thereby made possible. Here the two-dimensional template 30 is a full template which replicates the cross-sectional contour of the workpiece on both sides of the workpiece axis WSA.

The two-dimensional template 30 is provided here with an RFID tag 31 and with an alphanumeric code (inscription) 32 which is readable with the naked eye. The RFID tag 31 and the alphanumeric code 32 are examples of identification markings 33 with which the template 30 can be easily identified and, in particular, can be easily assigned to the original tool and the original clamping means.

As can be seen particularly well from FIG. 11, the cross-sectional contour of the workpiece is replicated in different ways on the two sides (halves) of the two-dimensional template 30. On the left side in FIG. 11, a section of a toothing of the workpiece is replicated in a first replication section 36 by an envelope curve 38, which corresponds to a tip circle of the toothing. On the right side in FIG. 11, in a second replication section 37 a further section of the toothing of the workpiece is replicated by an envelope curve 39, which corresponds to the root circle of the toothing (over the largest, here lower part of the axial extension of the toothing). Said section and further section of the workpiece are designed identically (i.e., they can be translated into one another by rotation of the workpiece, here by 180°). By means of the first replication section 36, collisions with machining components or substitute machining components can be checked in checking positions for which no engagement in the toothing of the workpiece is provided. With the second replication section 37, it is possible to bring the tool 7 with its toothing 7a (or, in other embodiments, a substitute tool) up to the root circle of the toothing on the substitute workpiece, i.e., to simulate full engagement with the toothing of the workpiece. By rotating the template 30 by (almost) 360°, collisions can be checked over the entire circumference.

A boundary marking 40 is applied to the two-dimensional template 30 in the area of the second replication section 37, which indicates to the operator where the toothing that has not been completely replicated would end in the area of the second replication section 37. This makes it easier for the operator to verify relative checking positions and then to detect possible collisions when using the second replication section.

FIG. 11 also clearly shows a typical light gap 72, which can be checked by the operator to detect collisions. In FIG. 11, the shown light gap 72 is situated between the tool holder 12 and the (radially inner) contour of the substitute workpiece 3. Since a sufficient light gap 72 remains between the substitute workpiece 3 and the tool holder 12 in the shown relative position of the machining components B and substitute machining components E, there is no collision. If contact were to occur between the substitute workpiece 3 and the tool holder 12 during rotation of the substitute workpiece 3 or the two-dimensional template 30 (i.e., if the light gap 72 were to disappear), a collision would be present.

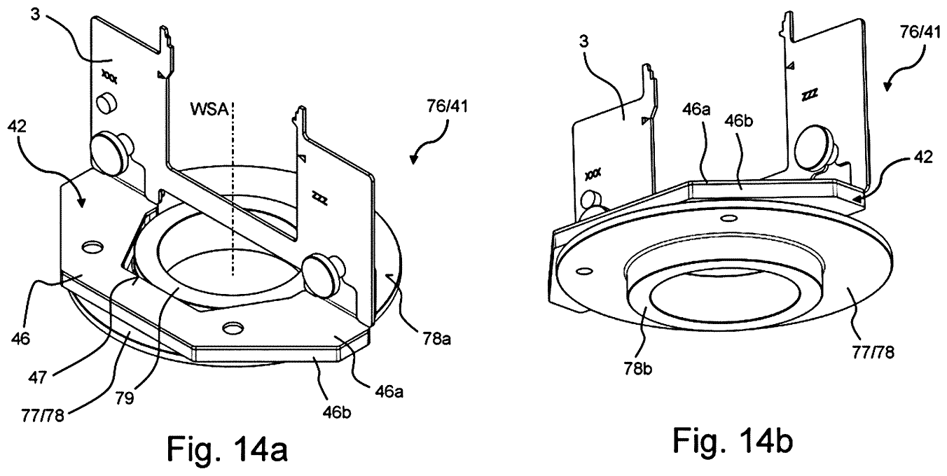

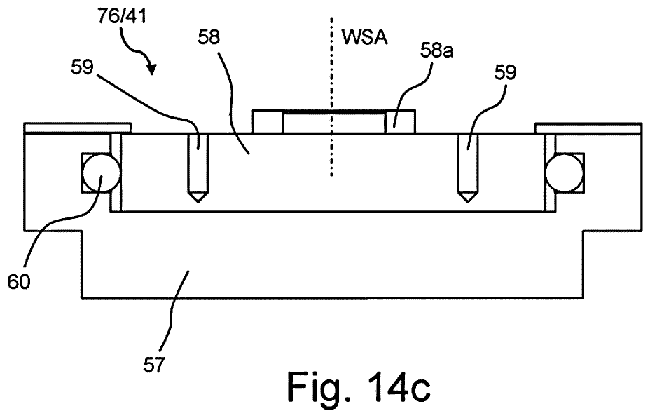

The two-dimensional template 30 is fastened here to an intermediate holder 76, which in turn is arranged on the original clamping means 11 of the machine tool 2. The original clamping means 11 is mounted on the workpiece spindle 4. Note that the original clamping means 11 is not used here in the collision test, but rather a substitute clamping means 29 co-formed by the two-dimensional template 30. The clamping means 11 serves here only for mounting (fastening) the intermediate holder 76. The intermediate holder 76 here comprises a template carrier 42 and a lower part 77 (largely concealed in FIG. 10), on which the template carrier 42 is fixed in a rotationally fixed manner by means of fastening elements 48, inter alia knurled screws 49. The two-dimensional template 30 is fixed to the template carrier 42, and the lower part 77 is fixed in the (original) clamping means 11. To rotate the substitute workpiece 3, the substitute workpiece 3 together with the intermediate holder 76 and clamping means 11 is rotated by means of the workpiece spindle 4 or the pivot bearing thereof. However, it is to be noted that by omitting the knurled screws 49, the intermediate holder 76 can also be used as an auxiliary rotary holder with a separate pivot bearing designed as a plain bearing (see FIG. 14a/FIG. 14b).

However, due to this design, the position (in the Z-direction) of the substitute workpiece 3 and of the substitute clamping means 29 (or template 30) during the collision check do not match the position of the workpiece and the original clamping means 11 during the actual workpiece machining. The substitute workpiece 3 and the substitute clamping means 29 are arranged “too high” above the original position by an offset 43.

In the embodiment shown in FIG. 9/FIG. 10/FIG. 11, the relative positions assigned to the checking positions are approached with the machine tool 2 as relative checking positions which correspond to the relative positions plus this offset 43. The offset 43 compensates for the fact that the substitute workpiece 3 and the substitute clamping means 29 are not attached to the machine tool 2 in the same way here as the corresponding original machining components B would be. The machine controller 2a is programmed to approach the relative checking positions adjusted in this way one after the other. Note that the offset 43 can be indicated on the substitute workpiece 3 in the inscription 32 or can also be stored in the RFID tag 31, so that the operator can input this offset in the machine controller, or the machine controller can automatically read and take over the value of the offset 43.

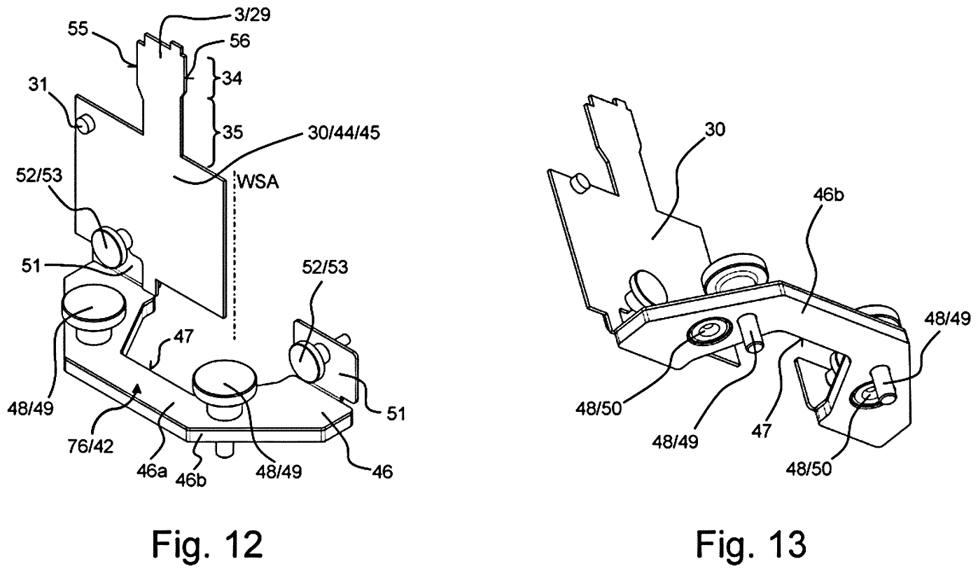

FIG. 12, in a perspective view obliquely from above, and FIG. 13, in a perspective view from below, again explain the structure of the template carrier 42 of the intermediate holder 76 of FIG. 9/FIG. 10/FIG. 11, wherein, deviating therefrom, a multiple template 44, which is designed as a half-template 45, is held on the template carrier 42.

The template carrier 42 is formed with a base plate 46 which is formed inward (direction towards workpiece axis WSA) with a recess in the form of a positioning prism 47. The fastening elements 48 are arranged on the base plate 46 in order to fasten the template carrier 42 for example on the lower part (see FIG. 10, ref. 77) of the intermediate holder or on a rotary plate (see FIG. 14c, ref. 58) of an auxiliary rotary holder, or optionally also directly on another structure such as a clamping means or a workpiece spindle. Knurled screws 49 and magnets 50 are shown here as exemplary fastening elements 48. The base plate 46 here comprises a cover plate 46a (typically made of metal) and an underlying plastic prism 46b.

Furthermore, the template carrier 42 here has two tabs 51 on which one or more two-dimensional templates 30 can be fastened, wherein again knurled screws 52 can be used as fastening elements 53 for the template or templates 30. As shown, the tabs 51 can be sheet metal sections bent up from the cover plate 46a or can be additional structures fastened to the base plate 46 (the latter not shown in more detail).

In the embodiment shown, the two-dimensional template 30 fastened to the template carrier 42 is selected as a multiple template 44. Here, the multiple template 44 is designed as a 2-fold template with two different sections 55, 56 of its edge contour, wherein each of these sections 55, 56 replicates the cross-sectional contour of another workpiece. Depending on the orientation in which the multiple template 44 is mounted on the template carrier 42, the multiple template 44 functions as a substitute workpiece 3 for the one or the other workpiece. In the orientation shown of the multiple template 44, the section 56 is used for the collision check, by which the cross-sectional contour of an internally toothed workpiece is partially replicated in an upper part 34. In a lower part 35, the section 56 also partially replicates a clamping means so that the multiple template 44 also functions simultaneously as a substitute clamping means 29. If the template 30 in FIG. 12 were mounted to the template carrier 42 in an orientation rotated 180° about a vertical axis, the section 55 would then be used for the collision check.

Since the multiple template 44 replicates the cross-section of a respective workpiece only on one side (in FIG. 12, the left side), the multiple template 44 is referred to as a half-template 45. A particularly good view of the collision situation can be obtained thereby.

FIG. 14a and FIG. 14b illustrate in perspective views a variant of the intermediate holder of FIG. 9/FIG. 10/FIG. 11. In the variant of FIG. 14 a/FIG. 14b, the intermediate holder 76 can be used as an auxiliary rotary holder 41. The template carrier 42 and the lower part 77 are largely designed as shown in FIG. 9/FIG. 10/FIG. 11 and FIG. 12/FIG. 13; only the essential differences are explained.

Here, the auxiliary rotary holder 41 comprises the template carrier 42 and the lower part 77. However, the template carrier 42 is not fixed to the lower part 77 in a rotationally fixed manner here but is merely placed with the positioning prism 47 against a receptacle 79 of the lower part 77. The receptacle 79 forms an annular projection with respect to an upper, planar sliding surface 78a of the lower part 77, on which the template carrier 42 rests with its plastic prism 46b. The plastic prism 46b can also be referred to as a sliding element. Furthermore, in this design, the lower part 77 can also be referred to as the sliding base 78 of the auxiliary rotary holder 41 or, due to its overall structure, in simplified fashion as a ring.

While the positioning prism 47 rests against the receptacle 79 and thereby centers the template carrier 42, the template carrier 42 can be rotated by hand as desired about the workpiece axis WSA (which passes through the center of the receptacle 79), wherein the template carrier 42 (or the plastic prism) slides with its underside on the sliding surface 78a. An actuation of the workpiece spindle is then not necessary for rotating the substitute workpiece 3.

The lower part 77 has an annular projection 78b on its underside, with which the lower part 77 can be clamped in the original clamping means, for example. The lower part 77 can, in particular, be made of steel.

FIG. 14c illustrates by way of example in cross-section the essential parts of an alternative intermediate holder 76 for the invention, which can also be used as an auxiliary rotary holder 41, and which can be used for example in the embodiment of the machine tool system of FIG. 9/FIG. 10/FIG. 11 instead of the intermediate holder there.

The auxiliary rotary holder 41 has a foot part 57 that typically can be clamped in an original clamping means (not shown here, but cf. FIG. 10, for example, ref. 11 there). In the foot part 57, a rotary plate 58 is rotatably mounted about an axis which, in use, corresponds to the workpiece axis WSA; in the design shown, a ball bearing 60 is used for this purpose. On the rotary plate 58, the template carrier (not shown here, but cf. e.g., FIG. 12/FIG. 13 or FIG. 9/FIG. 10/FIG. 11, ref. 42 there) is fastened. Here, the rotary plate 58 has threaded bores 59 for the fastening of the template carrier, into which knurled screws (ref. 49 in FIG. 9/FIG. 10/FIG. 11 or FIG. 12/FIG. 13) can be screwed in. In the embodiment shown, the rotary plate 58 has a centering projection 58a, which is circular-cylindrical here, for the seating of the positioning prism 47 of the template carrier 42.

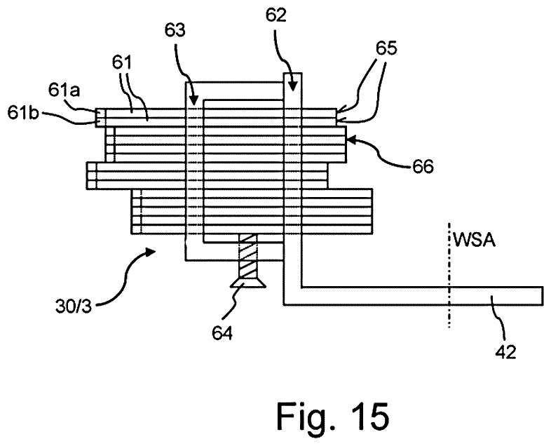

FIG. 15 illustrates a two-dimensional template 30 for the invention in a partially sectioned schematic side view, wherein the template 30 is designed to be adjustable and can therefore be used as a substitute workpiece 3 for a plurality of workpieces.

The template 30 is formed with a plurality of partial segments 61 arranged one above the other in the axial direction (vertical in FIG. 15), which partial segments 61 can be individually adjusted in the radial direction (horizontal in FIG. 15). The partial segments 61 are preferably fashioned as rectangular, in particular, square rods in cross-section. The partial segments 61 are guided in an inner guide (inner rod support) 62 and an outer guide (outer rod support) 63 of a template carrier 42. When a fastening element, here a set screw 64, is released, the adjustment of the partial segments 61 can take place, wherein the cross-sectional contour 66 of the desired workpiece is approximately replicated by the entirety of the partial segments 61 (rod packet, rod bundle) with the inner ends 65 of the partial segments 61. The set screw 64 can then be tightened, whereby the partial segments 61 are fixed in the radial direction. The template carrier 42 is typically part of an auxiliary rotary holder (not shown in more detail).

The partial segments 61 are each provided at their rear ends with a bend 61a, 61b in order to facilitate gripping of the partial segments 61 by an operator; the bends 61a, 61b here preferably point alternately in different directions. In FIG. 15, the partial segments 61 alternate with a bend 61a forward (out of the drawing plane) and partial segments 61 with a bend 61b rearward (into the drawing plane).

In FIG. 15, in the plain view from the side, hidden structures are indicated by dotted lines.

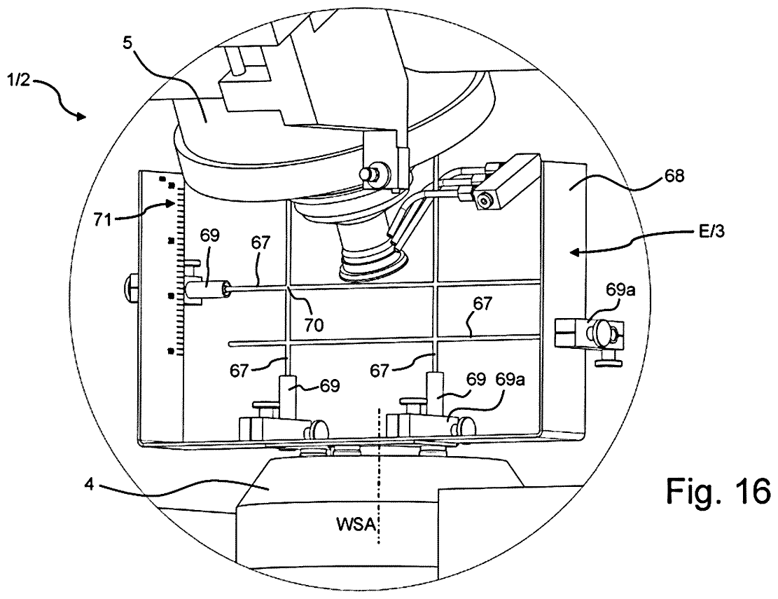

FIG. 16 shows, in a section in the region of the substitute workpiece 3, a further, exemplary embodiment of a machine tool system 1 according to the invention in a schematic side view, for carrying out the method according to the invention for collision checking, in a further exemplary variant. Only the essential differences from the design of FIG. 1/FIG. 2 are explained.

In the embodiment shown, the substitute workpiece 3 is formed by multiple light beams 67, which partially replicate the cross-sectional contour of the workpiece. The light beams 67 and their intersection points 70 here mark edges and corners of the cross-sectional contour of the workpiece. The light beams 67 here are laser beams that are generated by light beam sources 69 (for example commercially available laser pointers). The light beam sources 69 are mounted by means of source supports 69a on a here bracket-like support element 68. By rotating the substitute workpiece 3 or the carrier element 68 about the workpiece axis WSA, the collision situation can be checked over the entire circumference of the workpiece with very good visibility for an operator. Due to the light beams 67, colliding edges are usually also particularly easily detected by light reflections or interruption of the light beams 67 (which can be made easily visible in their course by some fog or smoke by means of the Tyndall effect).

The support element 68 can be part of an auxiliary rotary holder (the support element 68 being mounted for example on a rotary plate of the auxiliary rotary holder), or it can be mounted directly on an original structure (such as, as here, on the workpiece spindle 4).

A linear scale 71 is applied to the carrier element 68 here as an adjustment aid for adjusting the light beam sources 69.

The light beams 67 reliably exclude any damage to original machining components (for example the tool) that collide with the light beams 67.

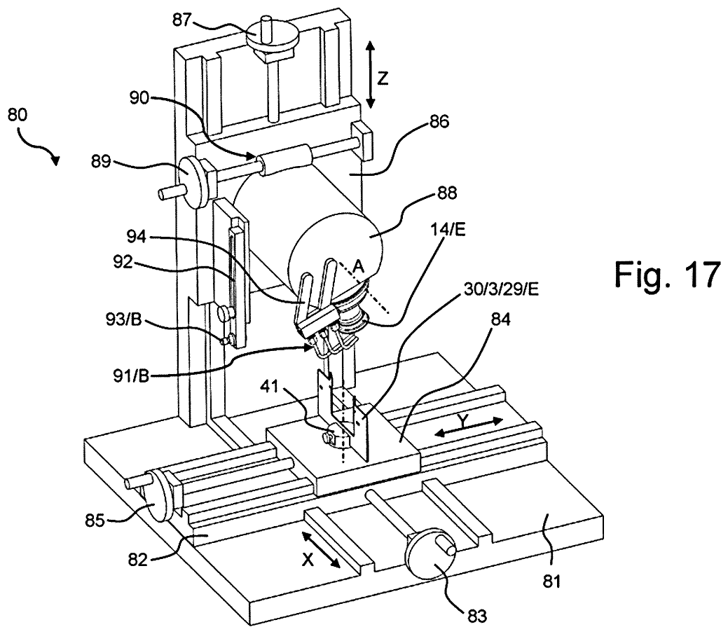

FIG. 17 shows a schematic perspective view of a model 80 with which the checking positions or relative checking positions for a collision checking according to the invention can be simulated. The original machine tool, as shown in FIG. 1 and FIG. 9, is then not required during the collision check according to the invention, so that machine downtime is avoided. The model 80 can completely simulate the machine axes of the machine tool of FIG. 1 and FIG. 9 for the collision check.

The model 80 has a table 81 on which an intermediate slide 82 can be moved with respect to the simulated machine axis X with a hand crank 83. On the intermediate slide 82, a substitute workpiece slide 84 can be moved along the simulated machine axis Y with a hand crank 85. A two-dimensional template 30 is held on the substitute workpiece slide 84 by means of an auxiliary rotary holder 41 and is rotatable about the simulated workpiece axis WSA. The two-dimensional template 30 here forms the substitute workpiece 3 and the substitute clamping means 29.

A model tool head 88 is mounted rotatably about the simulated machine axis A on a vertical slide 86, which can be moved vertically along the simulated machine axis Z by a hand crank 87. The simulated tool axis A can be actuated via the hand crank 89 by means of the pivot axis drive 90 (which here comprises a worm gear, not shown in more detail). A substitute tool 14, which can be pivoted about the simulated machine axis A, is held on the model tool head 88. Furthermore, here an original gas nozzle arrangement 91, which is adjustable with an adjusting device 94, is formed on the model tool head 88. In addition, on the vertical slide 86 an adjustment holder 92 is also provided, on which an original centering sensor 93 can here be adjusted. Alternatively, it is also possible to provide a substitute gas nozzle arrangement or a substitute centering sensor (not shown in more detail) on the model 80.

The simulated machine axes X, Y, Z, A are provided with scales not shown in detail, with which an operator can set the required checking positions or relative checking positions, if necessary, with an appropriate offset. At each checking position or relative checking position, the operator can then rotate the substitute workpiece 3 by means of the auxiliary rotary holder 41 in order to check the substitute machining components E (here ref. 3, 29, 14) and the machining components B (here ref. 91, 93) for collisions.

In summary, the invention relates to a method for collision checking of a machining process,
wherein a process-specific cycle is provided for the machining process, during which cycle multiple machining components (B) are to be moved relative to one another with at least one machine axis (A, X, Y, Z) on a machine tool (2), wherein the machining components (B) comprise at least one workpiece (20) and one tool (7), and at least during a part of the process-specific cycle the workpiece (20) is to rotate about a workpiece axis (WSA) and the tool (7) is to rotate about a tool axis (WZA), which is characterized in that in the process-specific cycle, at least one checking position is identified, wherein the checking position corresponds to a relative position of the machining components (B) set with the at least one machine axis (A, X, Y, Z), and in that, in order to check a respective checking position for collisions, the relative position of the machining components (B) is reproduced, wherein one or more substitute machining components (E) are used during reproducing, which each are a replica or partial replica of the corresponding machining component (B), and which comprise a substitute workpiece (3) which is a partial replica of the workpiece (20), wherein in the substitute workpiece (3) the workpiece (20) is replicated, at least over an axial partial region (17), only over a part of a circumference of the workpiece (20), and wherein, in the reproduced relative position, the substitute workpiece (3) is rotated about its workpiece axis (WSA). The invention provides a simple, cost-effective and safe method for collision checking of a machining process.

### LIST OF REFERENCE SIGNS

1 machine tool system
2 machine tool
2a machine controller
2b machine bed
3 substitute workpiece
4 workpiece spindle
5 tool spindle
7 tool
7a toothing (tool)
8 workpiece slide
9 tool slide
10 cross slide
11 clamping means
12 tool holder
13 gas nozzle arrangement
14 substitute tool
15 substitute tool holder
16 half-workpiece
16a partial workpiece
17 axial partial region
18 axial residual region
19 partial structure
20 workpiece
21 toothing (workpiece)
22 internal toothing (workpiece)
23 envelope surface (substitute workpiece)
24 envelope surface (substitute tool)
25 toothing (substitute tool)
26 magnet
27 auxiliary tool
28 centering sensor
29 substitute clamping means
30 two-dimensional template (substitute workpiece)
31 RFID tag
32 alphanumeric code
33 identification marking
34 upper part
35 lower part
36 first replication section
37 second replication section
38 envelope curve (substitute workpiece)
39 envelope curve (substitute workpiece)
40 boundary marking
41 auxiliary rotary holder
42 template carrier
43 offset
44 multiple template
45 half template
46 base plate
46a cover plate (upper part of the base plate)
46b plastic prism/sliding element (lower part of the base plate)
47 positioning prism (recess of the base plate)
48 fastening element (for template carriers)
49 knurled screw
50 magnet
51 tab
52 fastening element (for template)
53 knurled screw
55 section
56 section
57 foot part
58 rotary plate
58a centering projection of the rotary plate
59 threaded hole
60 ball bearing
61 partial segment
61a bend (forward)
61b bend (backwards)
62 inner guide
63 outer guide
64 set screw
65 inner end
66 cross-sectional contour
67 light beam
68 carrier element
69 light beam source
69a source carrier
70 intersection point
71 linear scale
72 light gap
73 step
74 two-dimensional template (substitute tool)
75 envelope curve (substitute tool)
76 intermediate holder
77 lower part
78 sliding base/ring
78a sliding surface
78b annular projection
79 receptacle
80 model
81 table
82 intermediate slide
83 hand crank
84 substitute workpiece slides
85 hand crank
86 vertical slide
87 hand crank
88 model tool head
89 hand crank
90 pivot axis drive
91 gas nozzle arrangement
92 adjusting holder
93 centering sensor
94 adjusting device (gas nozzle arrangement)
A machine axis
B machining component
E substitute machining component
WSA workpiece axis
WZA tool axis
X,Y,Z machine axes

What is claimed is:

1. A method for collision checking of a machining process, comprising the steps of:
providing a process-specific cycle for the machining process, during which cycle multiple machining components are to be moved relative to one another with at least one machine axis on a machine tool, wherein the machining components comprise at least one workpiece and one tool, and at least during a part of the process-specific cycle the workpiece is to rotate about a workpiece axis and the tool is to rotate about a tool axis;
in the process-specific cycle, identifying at least one checking position, which checking position is checked for collisions with respect to the machining components;
wherein the checking position corresponds to a relative position of the machining components set with the at least one machine axis;
and wherein, in order to check a respective checking position for collisions, reproducing the relative position of the machining components, wherein one or more substitute machining components are used during the reproducing, which are each a replica or partial replica of the corresponding machining component;
wherein the one or more substitute machining components comprise a substitute workpiece which is a partial replica of the workpiece;
wherein in the substitute workpiece the workpiece is replicated at least over an axial partial region only over a part of a circumference of the workpiece; and
wherein, in the reproduced relative position, the substitute workpiece is rotated about its workpiece axis.

2. The method according to claim 1, wherein the reproducing of the relative position of the machining components is performed on a model of the machine tool separate from the machine tool.

3. The method according to claim 1, wherein the reproducing of the relative positions of the machining components takes place on the machine tool.

4. The method according to claim 3, wherein the machine tool has at least one workpiece spindle with at least one clamping means, and the substitute workpiece is mounted with the clamping means for the reproducing.

5. The method according to claim 3, wherein the substitute workpiece is fastened to an intermediate holder for the reproducing, and the intermediate holder is fastened directly or indirectly to a workpiece spindle.

6. The method according to claim 4, wherein the substitute workpiece is fastened to an intermediate holder for the reproducing, and the intermediate holder is fastened directly or indirectly to the workpiece spindle, wherein the intermediate holder is fastened to the workpiece spindle with the clamping means of the workpiece spindle.

7. The method according to claim 3, wherein the substitute workpiece is fastened to a workpiece spindle of the machine tool for the reproducing, and for rotating the substitute workpiece about its workpiece axis the workpiece spindle of the machine tool is rotated.

8. The method according to claim 1, wherein the substitute workpiece is mounted on an auxiliary rotary holder for the reproducing, and that for rotating the substitute workpiece this substitute workpiece is rotated on the auxiliary rotary holder.

9. The method according to claim 1, wherein the substitute workpiece has an axial partial region in which the workpiece is replicated only over a part of a circumference of the workpiece, and has an axial residual region in which the workpiece is replicated over its full circumference, wherein in the axial partial region the part of the circumference has multiple substructures separate from one another in the circumferential direction.

10. The method according to claim 1, wherein the substitute workpiece is designed as a partial workpiece which replicates the workpiece at least in an axial partial region over at least ⅓ of its circumference and at most ⅔ of its circumference, wherein the partial workpiece is designed as a half-workpiece.

11. The method according to claim 1, wherein the substitute workpiece only replicates a cross-sectional contour of the workpiece completely or partially.

12. The method according to claim 11, wherein the substitute workpiece is formed by a two-dimensional template.

13. The method according to claim 12, wherein the two-dimensional template is designed as a multiple template which, at different sections of its edge contour, replicates the cross-sectional contours of different workpieces, in each case completely or partially.

14. The method according to claim 12, wherein the two-dimensional template has partial segments which are adjustable relative to one another, which are set in such a way that they completely or partially replicate the cross-sectional contour of the workpiece and/or of a clamping means.

15. The method according to claim 11, wherein the substitute workpiece completely or partially replicates the cross-sectional contour of the workpiece and/or of a clamping means by light beams.

16. The method according to claim 15, wherein the light beams replicate edges of the cross-sectional contour of the workpiece and/or of the clamping means, and/or that intersection points of the light beams replicate corner points in the cross-sectional contour of the workpiece and/or of the clamping means.

17. The method according to claim 1, wherein the one or more substitute machining components comprise a substitute tool that is a replica or partial replica of the tool.

18. The method according to claim 17, wherein the substitute tool is a partial replica of the tool, wherein in the substitute tool the tool, at least over an axial partial region, is replicated only over a part of a circumference of the tool, and wherein in the reproduced relative position the substitute tool is rotated about its tool axis.

19. The method according to claim 17, wherein the one or more substitute machining components comprise a substitute tool holder which is a replica or partial replica of a tool holder with which the tool is to be held on a tool spindle of the machine tool.

20. The method according to claim 1, wherein the one or more substitute machining components comprise a substitute clamping means which is a replica or partial replica of a clamping means with which the workpiece is to be held on a workpiece spindle of the machine tool.

21. The method according to claim 20, wherein the substitute clamping means in the reproduced relative position is rotated together with the substitute workpiece, wherein the substitute clamping means and the substitute workpiece are formed by a common two-dimensional template.

22. The method according to claim 1, wherein, in the case of one or more substitute machining components, a toothing of the corresponding machining component is replaced completely or partially by an envelope curve or envelope surface of the toothing.

23. The method according to claim 1, wherein the workpiece which is partially replicated by the substitute workpiece is an internally toothed workpiece.

24. The method according to claim 1, wherein at least one light gap is observed for collision checking during rotation of the substitute workpiece.

25. The method according to claim 1, wherein the one or more substitute machining components comprise at least one substitute machining component which has a first replication section and a second replication section, wherein these replication sections replicate two similarly formed sections of the corresponding machining component, and wherein a type of replication in the first replication section and in the second replication section is different, wherein the similar sections on the machining component bear a toothing, and the first replication section replicates a tip circle of the toothing, and the second replication section replicates a root circle of the toothing.

26. The method according to claim 1, wherein at least one boundary marking is applied to at least one substitute machining component, said boundary marking indicating the boundary of a structure of the associated machining component that is not, or not completely, replicated on the substitute machining component.

27. The method according to claim 1, wherein an identification marking is applied to at least one substitute machining component, which identification marking enables an identification of the substitute machining component and/or an assignment of the substitute machining component to the corresponding machining component, wherein the identification marking is readable by a person with the naked eye and/or machine-readable, and wherein the identification marking comprises an alphanumeric code and/or a QR code and/or a bar code and/or an RFID tag.

28. The method according to claim 1, wherein the machining components comprise at least one auxiliary tool, wherein the at least one auxiliary tool comprises a gas nozzle arrangement and/or a suction nozzle arrangement and/or a lubricant coolant nozzle arrangement and/or a centering sensor.

29. A method for preparing a machining process, comprising the method for collision checking according to claim 28, wherein furthermore for at least one checking position in the reproduced relative position a functional optimization of the at least one auxiliary tool takes place by positioning, aligning and/or selecting the auxiliary tool.

30. A machine tool system designed to carry out the method according to claim 1, the machine tool system comprising the machine tool for machining the at least one workpiece and comprising the one or more substitute machining components, each of which is the replica or partial replica of the corresponding machining component of the machine tool, wherein the one or more substitute machining components comprises the substitute workpiece which is the partial replica of the workpiece, wherein in the substitute workpiece the workpiece, at least over the axial partial region, is replicated only over the part of the circumference of the workpiece.

31. The machine tool system of claim 30, wherein the machine tool comprises an electronic machine controller that is programmed for carrying out the method, to approach for all identified checking positions associated relative checking positions of the substitute machining components and/or machining components arranged on the machine tool, wherein the relative checking positions are equal to the relative positions of the machining components in the process-specific cycle or the relative checking positions correspond to the relative positions of the machining components in the process-specific cycle plus an offset which is caused by a fastening of a respective substitute machining component on the machine tool differing from a fastening of a corresponding original machining component.

32. A use of the substitute machining component in the method according to claim 1, wherein the substitute machining component is the replica or partial replica of the corresponding machining component, wherein the substitute machining component is the substitute workpiece for the corresponding workpiece, wherein in the substitute workpiece the workpiece, at least over the axial partial region, is replicated only over the part of the circumference of the workpiece.
